(19) United States
(12) Patent Application Publication
(10) Pub. No.: US 2025/0218069 A1
(43) Pub. Date: Jul. 3, 2025

(54) DISPLAY SYSTEM AND DISPLAY METHOD

(71) Applicant: Rakuten Group, Inc., Tokyo (JP)

(72) Inventors: Wenyan XIAO, Tokyo (JP); Nicole Casshen, Tokyo (JP)

(73) Assignee: Rakuten Group, Inc., Tokyo (JP)

(21) Appl. No.: 18/991,927

(22) Filed: Dec. 23, 2024

(30) Foreign Application Priority Data
Dec. 27, 2023 (JP) 2023-220320

(51) Int. Cl. G06T 11/20; G06F 18/2431; G06Q 30/0601

(52) U.S. Cl. CPC G06T 11/203; G06F 18/2431; G06Q 30/0633

(57) ABSTRACT

A category classification includes one or more upper-level categories, and lower-level categories that are included in each of the upper-level categories. The one or more upper-level categories and the lower-level categories are used to classify targets. A method for displaying information that is classified into categories includes causing a computer to, based on information related to targets that are classified into each of the upper-level categories and the lower-level categories, execute displaying objects in a display area. The objects include one or more upper-level symbols, each representing a corresponding one of the one or more upper-level categories, and lower-level symbols, each representing the lower-level categories. The method also includes causing the computer to, based on the information, execute changing display of at least one of the objects in the display area.

### CROSS-REFERENCE TO RELATED APPLICATIONS

This application is based upon and claims the benefit of priority from Japanese Patent Application No. 2023-220320, filed on Dec. 27, 2023, the entire contents of which are incorporated herein by reference.

### BACKGROUND

### 1. Field

The present disclosure relates to a display system and a display method.

### 2. Description of Related Art

In electronic commerce (EC) sites, for example, a wide variety of product and service items are offered, and these items are displayed by categorizing them into multiple categories. Similarly, in content distribution services, such as those offering books, videos, or music, the content may be classified and displayed by category. For instance, Japanese Laid-Open Patent Publication No. 2015-210773 discloses a method for classifying, by category, websites that do not require login authentication and displaying a list of the classified category names on the initial screen of an information processing device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In the classification of the websites mentioned above, it is possible to switch between category-based display and time-based display. Additionally, the above-described publication discloses displaying content information in order from categories in which the user has a high level of interest. Thus, multiple methods are used to display items categorized into various categories, such as products, content, or websites. The optimal approach to displaying such items varies depending on the purpose of the display. As the number of items to be classified or the number of categories increases, the data volume grows, making it challenging to present the information in a clear and accessible manner.

For example, the number of items on an EC site can reach several million, requiring the handling of massive amounts of data for display. To present this extensive data clearly, new methods of representation that leverage data science are in demand.

An objective of the present disclosure is to provide a display system and display method for displaying information categorized by category.

A display system according to an aspect of the present disclosure displays information that is classified into categories. The category classification includes one or more upper-level categories, and lower-level categories that are included in each of the upper-level categories. The one or more upper-level categories and the lower-level categories are used to classify targets. The display system includes one or more processors and one or more memories that store computer program code and display data. The display data includes object data for displaying objects in a display area. The objects include one or more upper-level symbols, each representing a corresponding one of the one or more upper-level categories, and lower-level symbols, each representing the lower-level categories. The one or more processors are configured to read the program code and operate as instructed by the program code. The program code includes object display code configured to display the objects in the display area based on information related to the targets that are classified into each of the upper-level categories and the lower-level categories, and object change code configured to change display of at least one of the objects in the display area.

A display method according to an aspect of the present disclosure displays information that is classified into categories. The category classification includes one or more upper-level categories, and lower-level categories that are included in each of the upper-level categories. The one or more upper-level categories and the lower-level categories are used to classify targets. The method includes causing a computer to, based on information related to the targets that are classified into each of the upper-level categories and the lower-level categories, execute displaying the objects in the display area. The objects include one or more upper-level symbols, each representing a corresponding one of the one or more upper-level categories, and lower-level symbols, each representing the lower-level categories. The method includes causing the computer to, based on the information, execute changing display of at least one of the objects in the display area.

Other features and aspects will be apparent from the following detailed description, the drawings, and the claims.

### BRIEF DESCRIPTION OF THE DRAWINGS

FIG. 1 is a diagram illustrating the schematic configuration of a display system according to the present embodiment.

FIG. 2 is a diagram illustrating the schematic configuration of some devices in the display system shown in FIG. 1.

FIG. 3 is a diagram illustrating the relationship between multiple categories.

FIG. 4 is a schematic diagram illustrating an example of the display area.

FIG. 5 is a diagram illustrating the display screen that includes a main screen and a sub-screen.

FIG. 6 is a diagram illustrating one upper-level symbol and multiple lower-level symbols.

FIG. 7 is a flowchart illustrating the display method of the present embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

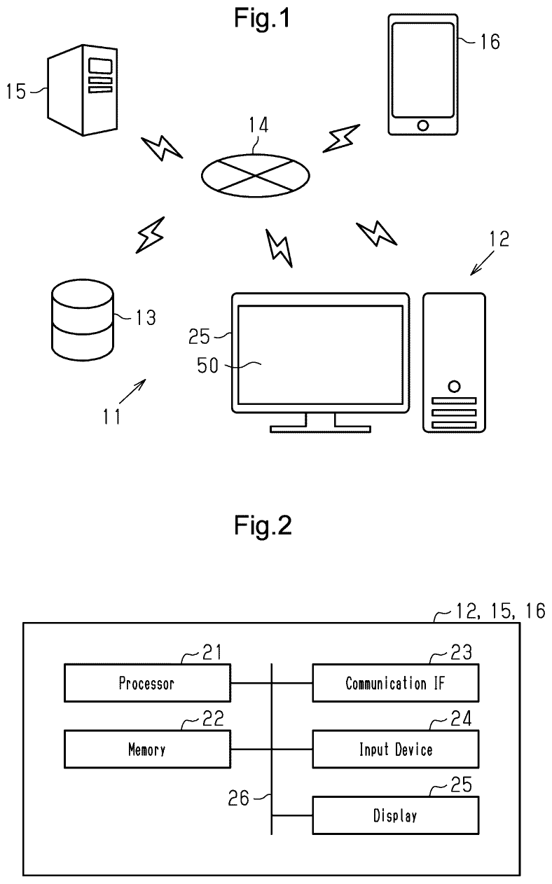

An example of a display system 11 and a display method for displaying categorized information will now be described with reference to FIGS. 1 to 7. The present disclosure is not limited to those exemplified and is shown by the scope of the claims. It is intended to include all modifications within the meaning and range equivalent to the scope of the claims.

### Overview of Data Display System

As shown in FIG. 1, the display system 11 according to the present disclosure includes a display device 12. The display system 11 may further include a database 13. The database 13 may be stored in a server device (not shown). The display device 12 can access the database 13 via the network 14. The display device 12 may include part or all of the database 13. A web server 15 may be capable of accessing the database 13 via the network 14. The web server 15 provides an EC site for offering products or services.

Targets transacted on EC sites can include not only tangible products but may also include services (e.g., electronic tickets, accommodation reservations, insurance products, or investment products). Hereinafter, the products or services transacted on the EC site will collectively be referred to as items. In this example, an item is an instance of a target that is classified into categories, and the information related to a target includes various types of information regarding the transaction of items.

User terminals 16 may be capable of communicating with the web server 15 via the network 14. Each user terminal 16 is an information processing device operated by the user, such as a smartphone, a personal computer, or a tablet. The display device 12, the web server 15, and the user terminal 16 are each an example of a computer. In response to requests from one or more user terminals 16, the web server 15 provides various information or processing results to each user terminal 16.

The network 14 includes, for example, the Internet, a wide area network (WAN), a local area network (LAN), a provider terminal, a wireless communication network, a wireless base station, and a dedicated line. All the combinations of the devices shown in FIG. 1 do not necessarily have to communicate with one another. The network 14 may partially include a local network.

FIG. 2 shows the basic configuration of computers such as the display device 12, the web server 15, and the user terminal 16. The computer includes, for example, one or more processors 21, one or more memories 22, and a communication interface (IF) 32. The computer may further include an input device 24 and a display 25. The one or more processors 21, the one or more memories 22, a communication IF 23, the input device 24, and the display 25 are connected to each other by a communication bus 26. The configurations of the display device 12, the web server 15, and the user terminal 16 may differ from one another.

Each of the one or more processors 21 is, for example, processing circuitry configured to execute various software processes. The processing circuitry may include a dedicated hardware circuit (e.g. ASIC) used to process at least some of the software processes. That is, the software processes may be executed by processing circuitry that includes at least one or more software processing circuits or one or more dedicated hardware circuits.

Each of the one or more processors 21 is, for example, a central processing unit (CPU), a graphics processing unit (GPU), a microprocessor unit (MPU), a field-programmable gate array (FPGA), or any other arithmetic unit. The processor 21 executes a series of instructions included in a computer program stored in the memory 22 in response to a given signal or when a predetermined condition is satisfied.

Each of the one or more memories 22 may include, for example, a random-access memory (RAM) or any other volatile memory. The memory 22 may be configured to temporarily store programs and data. The memory 22 may include a storage for permanently retaining data, including programs. The programs include applications and an operating system. The storage may be, for example, a read-only memory (ROM), a hard disk device, a flash memory, or any other non-volatile storage device. The storage may be a detachable storage device, such as a memory card.

The communication IF 23 is configured to connect to the network 14. The communication IF 23 is configured to communicate with other devices connected to the network 14. The communication IF 23 is implemented as, for example, a local area network (LAN) or any other wired communication IF. The communication IF 23 may be implemented as, for example, Wi-Fi®, Bluetooth®, or any other wireless communication IF, but is not limited thereto.

The input device 24 is, for example, a keyboard and a mouse, and may include buttons, keys, switches, a touchpad, or a microphone. The display 25 may be, for example, a liquid crystal monitor or an organic electro luminescence (EL) monitor, or may be a touch screen having a touch panel that also serves as the input device 24.

The database 13 is configured to store various types of data related to the operation of an EC site. The database 13 includes, for example, a user database, a store database, an item database, and a transaction database. The database 13 may further include a definition database. The web server 15 may include part of or all of the database 13. The web server 15 reads information related to a transaction from the database 13 and updates the database 13 in accordance with the transaction. The display device 12 is configured to read the data necessary for display from the database 13.

The user database includes registration information related to a user who uses the EC site. Examples of the registration information include, but are not limited to, the name, age, gender, address, account, email address, user ID, and settlement information of each user. Examples of the settlement information include credit card numbers, debit card numbers, and direct debit account numbers. The user database may include a purchase history of each user on the EC site. Examples of the purchase history may include, but are not limited to, purchased items, category name and category (including upper-level categories and lower-level categories) of items, date and time of purchase, and purchase amount.

The store database includes registration information related to stores (or business operators) operating on the EC site. Examples of the store registration information may include, but are not limited to, the name of each store, store ID, store location, sales items, and category name and category (including upper-level categories and lower-level categories) of the sales items. The store database may include a sales history on the EC site of each store. Examples of the sales history may include, but are not limited to, sales items, category name and category (including upper-level categories and lower-level categories) of items, and transaction amount.

Examples of the item database may include, but are not limited to, the name, item ID, store listing products, price, model number, category name, category (including upper-level categories and lower-level categories), attribute (e.g., size or color), and transaction history of each item. The transaction database includes a transaction history on the EC site. Examples of the transaction history may include, but are not limited to, the transaction ID, the purchaser (user), the seller (store), a transaction item, information related to the transaction item, the category name and category (including upper-level categories and lower-level categories) of items, the transaction date and time, and the transaction amount for each transaction.

### Category Classification in EC Site

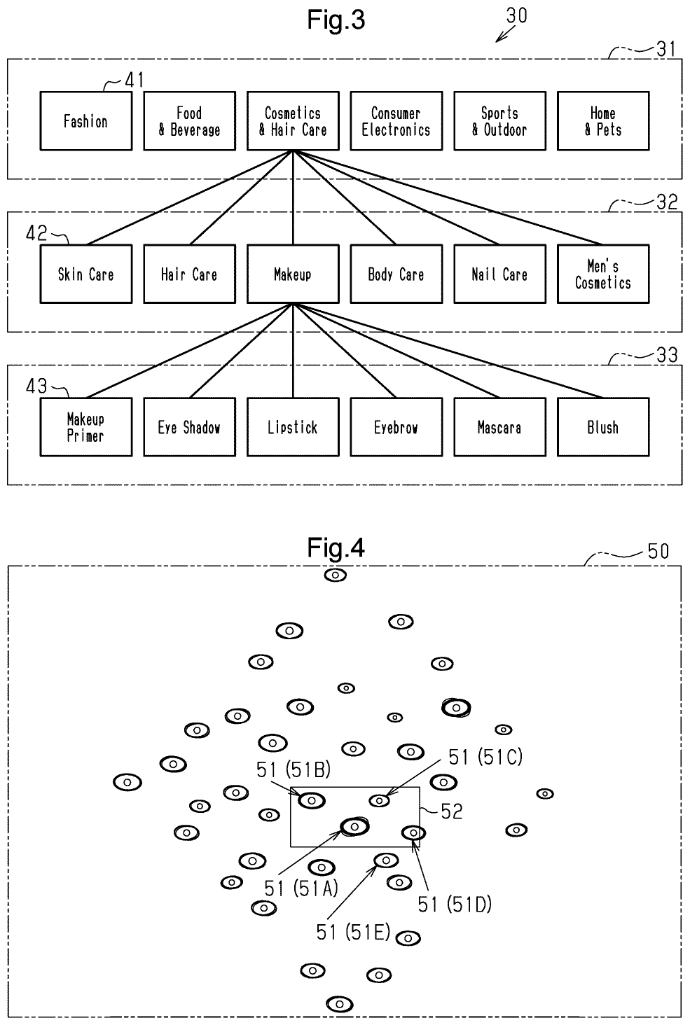

As illustrated in FIG. 3 with part of a category classification 30, the EC site handles a wide variety of items. These items are generally classified into hierarchical categories. Each category is assigned a category name to facilitate the management and search of items. The characters listed in categories 41 to 43 in FIG. 3 represent examples of category names.

If the category classification 30 has a two-level structure, the category classification 30 may include upper-level categories 41 (e.g., fashion, cosmetics and hair care, and others) in a first level 31 and lower-level categories 42 (e.g., skin care and hair care) included in each upper-level category 41. The upper-level category 41 is also referred to as the category of the first level 31. The lower-level category 42 is also referred to as the category of a second level 32. The lower-level categories 42 are included in the second level 32, which is beneath the first level 31. The second level 32 is a lower level of the first level 31. If the category classification 30 has a three-level structure, a third level 33 may be further provided beneath the second level 32. Each lower-level category 42 may include categories 43 in the third level 33. The third level 33 is a lower level of the second level 32. The number of levels and the number of categories may be increased or decreased.

In operating an EC site, various data analyses are conducted to properly manage the items handled and to develop effective sales strategies. For example, the display device 12 is configured to display the classification of items listed on an EC site and the trends of their transactions in a display area. As shown in FIG. 1, the screen of the display 25 in the display device 12 is a display area 50 in this example.

The one or more memories 22 of the display device 12 are configured to store display data. At least part of the display data may be linked to user data from the database 13, such as the purchase history of the user. Alternatively, or in addition, at least part of the display data may be linked to at least one of the item database or the transaction database. In this case, data such as purchase history may be aggregated values (e.g., the total sales value) for a specified period (e.g., on a monthly or yearly basis), or may use a ratio compared to the previous period (e.g., the previous month or year) for the specified period.

The display data may be designed to align to a specific theme. For example, to represent a multi-level category structure, a design modeled after natural systems, such as an ecosystem, may be used, or a design resembling a planetary system may also be used. In this case, the display data may include background data aligned with a theme and display objects. The theme of the display data is preferably designed such that the user can readily recognize the relationship between categories, including upper-level categories and lower-level categories.

### Example of Displaying Category Classification

As shown in FIGS. 4 to 6, in this example, display data themed around planetary systems 51 (51A to 51E) floating in space is used. In FIGS. 4 to 6, the background is depicted as white for illustrative purposes. In reality, the background created using the background data is an image representing a black colored outer region of the space theme of the display data to represent space in two or three dimensions. Each of the planetary systems 51 represents multiple upper-level categories 41.

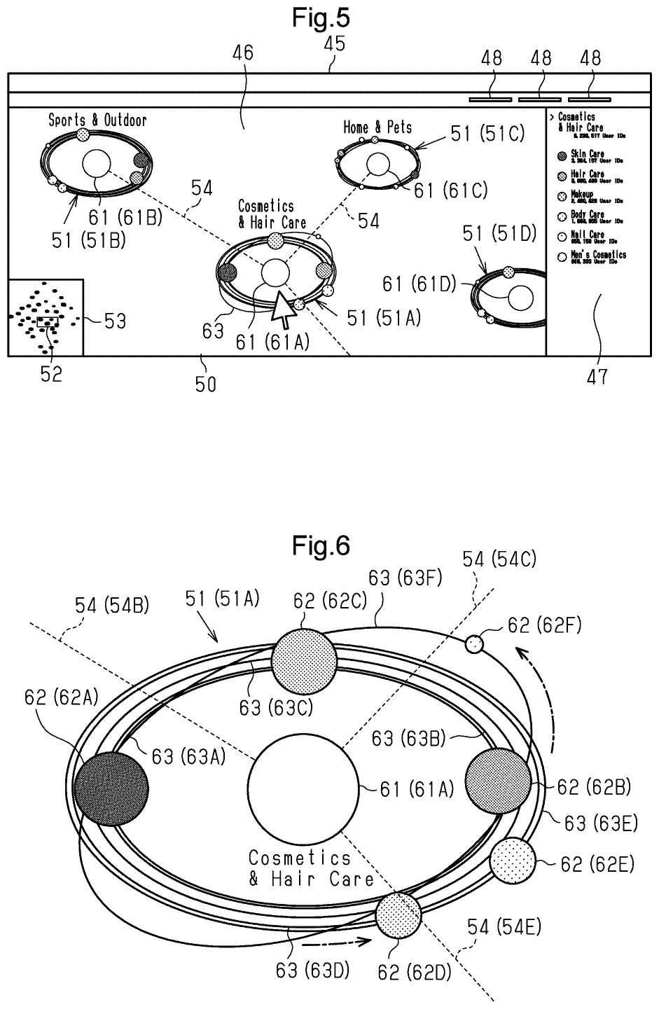

The display data may include object data for displaying objects that are to be displayed in the display area 50. As shown in FIGS. 5 and 6, the objects may include upper-level symbols 61 (61A to 61D, excluding 61E and 61F, which are not shown in the drawings) and lower-level symbols 62 (62A to 62F). Each of the upper-level symbols 61 represents multiple upper-level categories 41. Each of the lower-level symbols 62 represents multiple lower-level categories 42. The objects may include a path 63 on which each lower-level symbol 62 moves. The path 63 is positioned with respect to the upper-level symbol 61. The path 63 may always be displayed as an object or may be hidden.

The processor 21 of the display device 12 may be configured to display multiple objects, in the display area 50, including multiple upper-level symbols 61 and multiple lower-level symbols 62 based on the information related to items classified into each of the upper-level category 41 and the lower-level category 42. Further, the processor 21 of the display device 12 may be configured to control the display of one or more of the objects (e.g., multiple lower-level symbols 62 corresponding to each upper-level symbol 61) in the display area 50.

Controlling the display may include at least one of moving multiple lower-level symbols 62 along the path 63 based on the corresponding upper-level symbol 61 or altering the display of the lower-level symbols 62 or the path 63. Additionally, controlling the display may include altering at least one of the following parameters based on the information related to the items classified into each lower-level category 42: the movement speed, the movement range, or the rate of change in the display of the corresponding lower-level symbol 62 or the path 63. Such objects that move or undergo display changes are also referred to as dynamic objects. The attribute related to the dynamics of a dynamic object is referred to as a dynamic attribute. Examples of the dynamic attribute include, but are not limited to, at least one of the movement speed, the movement range, the display range, or the rate of display changes.

As shown in FIG. 5, when the display area 50 is defined by a two-dimensional display window 45, the display window 45 may include a main screen 46 and a sub-screen 47. The display window 45 may be displayed upon launching an application. The main screen 46 may display a navigation window 53 that shows an overview of the displayed content. The navigation window 53 may display a display frame 52 that indicates the display range of the main screen 46.

The main screen 46 may display objects that include one upper-level symbol 61 and multiple lower-level symbols 62. The sub-screen 47 may display information related to items classified into the selected category from the upper-level category 41 or the lower-level category 42. The category 41 or 42 may be selected by selecting the corresponding symbol 61 or 62. The outline arrow overlapping the planetary system 51A in FIG. 5 represents a mouse pointer.

The display window 45 may include one or more buttons 48 to change the displayed content (e.g., set a displayed color, select a displayed category, or select displayed data). By operating these buttons 48, it is possible to, for example, change the displayed colors of various display objects, modify the representation theme, select the upper-level symbol 61 (or the upper-level category 41) to be displayed, and modify the target period of data. The number of the buttons 48 and button operation details may be changed.

The processor 21 of the display device 12 may display, when selecting one of the upper-level symbols 61, additional information related to the upper-level category 41 corresponding to the selected upper-level symbol 61 in the sub-screen 47. The additional information may include information related to each of multiple lower-level categories 42 that are included in the upper-level category 41. In the example shown in FIG. 5, the sub-screen 47 displays the category names of each lower-level category 42 and the number of users who have purchased items from that lower-level category 42.

The arrangement of multiple upper-level symbols 61 may be determined based on the data of targets classified into the corresponding upper-level categories 41. For example, the distances between the upper-level symbols 61 may be determined based on the correlation or correlation level between the corresponding upper-level categories 41. The correlation level between the two upper-level categories 41 may be calculated based on the number of purchasers (users) who have purchased two items that are respectively classified into the two corresponding upper-level categories 41. For example, if a large number of users who have purchased products in the “cosmetics and hair care” category also purchase products in the “home and pets” category, then the “cosmetics and hair care” category and “home and pets” category share many overlapping purchasers as their customer segment and thus have a relatively high correlation level.

As a result of arranging multiple upper-level symbols 61 based on these rules, the upper-level symbol 61 placed relatively near the center of the display area 50 corresponds to the upper-level category 41 that has a purchaser segment overlapping with other upper-level categories 41. The upper-level category 41 corresponding to the upper-level symbol 61 located around the display area 50 indicates an independent purchaser segment. That is, that upper-level category 41 has a purchaser segment that exclusively purchases items from that category 41. The upper-level category 41 that has a purchaser segment overlapping with other upper-level categories 41 is important from a promotional perspective, even if its total sales value is relatively small.

Multiple objects may include one or more lines 54 (54B, 54C, and 54E). Each line 54 may be displayed so as to connect at least two of the upper-level symbols 61 to each other. Each line 54 may represent a correlation or a correlation level between two upper-level categories 41 corresponding to the two upper-level symbols 61 connected to each other by that line 54. For example, some of the upper-level symbols 61 that have a particularly high correlation level may be connected to each other by the line 54 (54B, 54C, or 54E). In this case, the higher the correlation level, the thicker line 54 may be rendered. The line 54 may be a straight line, a wavy line, or a curved line, but is not limited to these forms. Alternatively, the line 54 may be designed according to the representation theme. Instead of changing the thickness of the line 54 according to an index such as correlation level, its blinking speed may be changed.

The line 54 may be a movement line indicating a movement pattern of the user between the upper-level categories 41. The movement pattern includes a pattern in which a user who has purchased an item classified into one of two upper-level categories 41 (e.g., the “cosmetics and hair care” category) during a period purchases an item classified into the other upper-level category 41 (e.g., the “home and pets” category) during another (subsequent) period.

If the movement has a direction like a movement pattern, the movement line 54 may be a broken line to indicate the direction of the movement by the blinking direction, or it may indicate the direction of the movement with an arrow. For example, if the movement line 54 is directed from the “cosmetics and hair care” category toward the “home and pet” category, it indicates that a certain number of purchasers who purchased items in the “cosmetics and hair care” category in the previous period have purchased items in the “home and pet” category in the current period.

As shown in FIG. 6, each upper-level symbol 61 may be represented as a central star of a planetary system 51 floating in space. Multiple lower-level symbols 62 corresponding to one upper-level symbol 61 are represented as planets revolving in paths 63 (63A to 63F) centered around the corresponding central star (upper-level symbol 61). Since the symbols 61 and 62 represent stars, circular (spherical) objects are used. However, the shape of each object may be changed depending on the representation theme. In this example, a corresponding category name along with the upper-level symbol 61 is displayed as text in the display area 50. The category name of the lower-level symbol 62 may be displayed in the display area 50 in response to an operation such as mouseover.

The path 63 is an elliptical shape that simulates the orbit of a planet. However, the path 63 may be shaped such that each of multiple lower-level symbols 62 corresponding to one upper-level symbol 61 are positioned or moved with respect to the upper-level symbol 61. For example, the shape of the path 63 may be changed to be an arc, an ellipse, or a circle in accordance with the representation theme. Similarly, the display changes in the lower-level symbol 62 are not limited to rotational motion but may also be changed to pendular motion, linear motion, reciprocating motion, oscillation, blinking, or changes in size. If the lower-level symbol 62 does not move, the path 63 may simply be a line indicating the distance or relationship to the upper-level symbol 61.

The movement speed of the lower-level symbol 62, which travels along the path 63, may vary according to the information related to items classified into the corresponding lower-level category 42. For instance, when the data of the current period data being displayed (e.g., the total sales value) has a higher growth rate compared to the previous period (either the previous month or the previous year), the movement speed may be set to be higher. For instance, in the example of FIG. 6, the lower-level symbol 62F has a greater orbital speed than the other lower-level symbols 62 because the rate of increase in the total sales for the corresponding lower-level category 42 (e.g., “men's cosmetics”) is greater than those of other lower-level categories 42.

The display device 12 (the processor 21) may be configured to control the display in the display area based on the calculation results obtained using various types of data, including user data. For example, the size or color of at least one of the upper-level symbol 61 or the lower-level symbol 62 may be determined based on the information (e.g., the total sales value) of items classified into the corresponding category 41 or 42.

For example, in FIG. 6, multiple lower-level symbols 62 relative to one upper-level symbol 61 determine the arrangement of colors (e.g., orange and green) of the lower-level symbols 62B to 62E between the lower-level symbol 62A and the lower-level symbol 62F. This is determined by setting the lower-level symbol 62A, in which the total sales value of the item classified into the corresponding category 42 is highest, to a warm color (e.g., red), and setting the lower-level symbol 62F, in which the total sales value is lowest, to a cool color (e.g., purple). Further, multiple lower-level symbols 62 relative to one upper-level symbol 61 determine the sizes of the lower-level symbols 62B to 62E between the lower-level symbol 62A and the lower-level symbol 62F. This is determined by setting the lower-level symbol 62A, in which the total sales value is highest, to the maximum size, and setting the lower-level symbol 62F, in which the total sales value is lowest, to the minimum size. In these cases, the size or color may be determined based on other quantities, such as the number of transaction items or the number of purchasers, instead of the total sales value. Scaling the size in direct proportion to the data may result in poor visual balance. Therefore, adjusting the relative size according to an appropriate ratio based on predefined calculations is recommended.

When one of multiple upper-level symbols 61 or one of multiple lower-level symbols 62 is selected, the data linked to the category 41 or 42 corresponding to the selected symbol may be displayed on the sub-screen 47 or in another window. For example, when one lower-level symbol 62 is selected, the total sales value of the item corresponding to the lower-level category 42 or the list of purchasers (the list of users) of that item may be displayed.

The arrangement of multiple lower-level symbols 62 relative to one upper-level symbol 61 may be determined based on the information related to the items classified into the corresponding lower-level categories 42. For example, the distance of each lower-level symbol 62 and the path 63 from the upper-level symbol 61 may be reduced in proportion to the increase in the total sales value of the item in the corresponding lower-level category 42. In this case, the distance to the upper-level symbol 61 may be determined based on other quantities, such as the number of transaction items or the number of purchasers, instead of the total sales value.

In the example of FIG. 6, each of the path planes of multiple paths 63 centered around one upper-level symbol 61 is inclined with respect to the same reference plane (not shown; e.g., a horizontal plane) at an inclination angle corresponding to the information related to the item classified into the corresponding lower-level category 42. The inclination angle may be determined based on information that is different from the size or color of the lower-level symbol 62 or different from the upper-level symbol 61. For example, the greater the growth rate of the total sales value compared to the previous period (e.g., the previous month or the previous year), the steeper the inclination angle may be made. In the example of FIG. 6, the lower-level category 42F has a smaller total sales value than the other lower-level categories 42A to 42E, but has a higher growth rate of the total sales value than them. That is, it is indicated that the lower-level category 42F is a best-selling category.

### Method for Displaying Category Classification

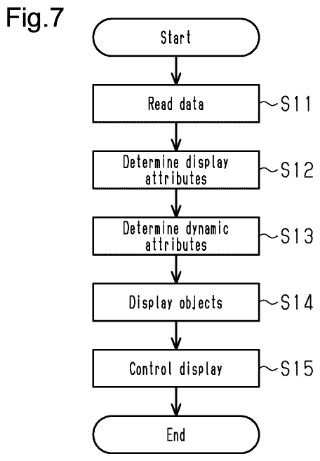

FIG. 7 illustrates the method for displaying category classification. For example, the sequence shown in FIG. 7 begins with an operation to display the display window 45 (e.g., launching the application) and ends with an operation to close the display window 45 (e.g., exiting the application).

First, in step 11, the processor 21 of the display device 12 reads, from the database 13, data that is to be displayed (e.g., the purchase history or transaction history during a designated period). Next, in step S12, the processor 21 of the display device 12 performs a calculation using the read data to determine the display attributes of various objects (e.g., the symbols 61 and 62, the path 63, and the line 54) that are displayed on the display area 50. Examples of the display attributes include the size or color of each of the symbols 61 and 62, the distance between them, or the inclination angle of the path 63.

In step S13, the processor 21 of the display device 12 performs a calculation using the read data to determine the dynamic attributes (e.g., movement speeds) of dynamic objects (e.g., lower-level symbols 62). Step S13 may be performed before step S12 or simultaneously with step S12.

In step S14, the processor 21 of the display device 12 uses the display attributes determined in step S12 to display the objects (e.g., the symbols 61 and 62, the path 63, and the line 54) in the display area 50. In step S15, the processor 21 of the display device 12 performs display control for the dynamic objects based on the dynamic attributes determined in step S13 (e.g., control for the movement of the lower-level symbol 62). Step S15 may be initiated simultaneously with step S14.

Some or all of the objects to be displayed may be displayed based on specified display attributes without performing calculations. If the display attributes of all objects are specified, step S12 does not have to be performed. Similarly, dynamic attributes may be specified for dynamic objects in advance. If the dynamic attributes of all dynamic objects are specified, step S13 does not have to be performed.

### Operation of Present Disclosure

Various objects displayed in the display area 50 are not merely illustrations designed for aesthetic appeal. Also, the conditions for displaying the objects (e.g., display attributes and dynamic attributes) are determined based on information related to items classified into each of the upper-level category 41 and the lower-level category 42. Thus, the information related to the items is clearly visualized. Further, movement of certain objects (e.g., orbital movement of the lower-level symbol 62) or change in the display (e.g., blinking of the movement line 54) allows the temporal variation in the information to be visualized through the movement speed or change speed.

Display data can also be generated to represent a three-dimensional outer region of space. However, when the display area 50 is two-dimensional, the visible content appears as a two-dimensional screen. In such two-dimensional screens, a three-dimensional environment can be represented by creating a sense of depth from the shape of the path 63 and the movement of the lower-level symbols 62 displayed in the display area 50. When the display data is generated in dimensions of three or more, an operation of changing the viewpoint with respect to the display area 50 may be performed.

One example of a conventional data display method is to present the total monthly sales values of lower-level categories 42 in a table. In such a table, only numbers are listed in rows and columns, making it difficult to visually grasp features such as increases and decreases in sales values or differences between categories. Moreover, when converting the table data into a graph, it is challenging to represent multiple features in a single graph. The display method of the present disclosure allows data differences or dynamics to be visualized simultaneously by reflecting data in the display attributes or dynamic attributes (e.g., the size, color, arrangement, movement speed, or inclination angle) of objects.

If a large number of objects are displayed or moved in different manners, the increase in the amount of information may make it difficult to understand the displayed data. In the present disclosure, since the display is designed around themes such as an outer region of space, which a large number of people have a basic understanding of, viewers can intuitively grasp the patterns in the shapes or movements of objects. Thus, even if the display contains a large amount of information, the worldview represented by the objects allows viewers to comprehensively interpret the data. Specifically, they can first understand the arrangement of multiple upper-level symbols 61, then understand the planetary system corresponding to each upper-level category 41, and grasp the states of the lower-level categories 42 from the arrangement, sizes, and movements of multiple lower-level symbols 62.

In this example, the size and color of the lower-level symbols 62 represent the proportions relative to a total sales value. Additionally, for example, the inclination angle of the path 63 and the movement speeds of the lower-level symbols 62 correspond to the growth rate of the total sales value. Thus, similar meanings are assigned to related expressive elements. In this manner, properly reflecting the meaning of data in the representation of objects enables more intuitive understanding.

The displayed content of the display area 50 can be changed, for example, by executing the control of steps S11 to S15 again in response to the operation of the button 48. This allows information related to the items to be viewed from diverse perspectives. In addition, objects are linked to actual data. This allows the data linked to the selected objects, such as the lower-level symbols 62, to be output. For example, the data on the current best-selling categories can be obtained by selecting a lower-level symbol 62 with a relatively large inclination angle of the path 63.

For example, an organization managing an EC site may assign a promotion manager to each of the categories 41 and 42. This allows the manager to extract user information from categories highly correlated with the manager's assigned category, thereby enabling the manager to carry out promotions for that category. Advancing promotions across categories in this manner enhances overall sales promotion for the EC site.

### Advantages of Present Disclosure

The present disclosure has the following advantages.
(1) The information related to the categories 41 and 42 is represented using the symbols 61 and 62. This allows the item data of the upper-level category 41 and the item data of the lower-level category 42 to be visualized. Further, for example, changing the display of some objects (e.g., lower-level symbols 62) allows the lower-level symbols 62 to be noticeable and allows the changes in the information to be reflected on the changes in the display.
(2) Multiple lower-level symbols 62 are used as dynamic objects relative to one upper-level symbol 61 to determine the movement speeds of these lower-level symbols 62 based on data. This allows differences in data to be visualized between multiple lower-level categories 42.
(3) The shapes, sizes, colors, or arrangement of objects including the symbols 61 and 62 are determined based on relevant data. This allows the data to be visualized.
(4) The arrangement of multiple lower-level symbols 62 relative to one upper-level symbol 61 is determined based on the information related to the items classified into the corresponding lower-level categories 42. This allows the differences in the item data of multiple lower-level categories 42 relative to one upper-level category 41 to be visualized.
(5) Multiple lower-level symbols 62 are moved along the path 63 with respect to the corresponding upper-level symbol 61. This allows the item data of the lower-level category 42 corresponding to each lower-level symbol 62 to be visualized.
(6) The inclination angles of multiple paths 63 are determined based on relevant data. This allows the differences in the data to be visualized.
(7) The upper-level symbols 61 are connected to each other by the line 54. This allows the correlation or correlation level between the corresponding upper-level categories 41 to be visualized.
(8) The upper-level symbols 61 are connected to each other by the movement line 54. This allows the movement dynamics of users between the corresponding upper-level categories 41 to be visualized.
(9) The distances between multiple upper-level symbols 62 are determined based on the correlation or correlation level between the corresponding upper-level categories 41. This allows the correlation between the upper-level categories 41 to be visualized.
(10) The correlation level between two upper-level categories 41 is calculated based on the number of purchasers (users) who have purchased two items that are respectively classified into the two corresponding upper-level categories 41. This allows the number of purchasers overlapping with each other in the two upper-level categories 41 to be visualized.
(11) The display attributes and dynamic attributes of objects based on quantities (e.g., the total sales value, the total sales volume, or the number of purchasers). This allows the corresponding quantity data to be visualized.
(12) Display attributes are determined based on the quantity for the current period (specified period), and dynamic attributes are determined based on the rate of change between the quantity for the previous period and the quantity for the current period. This allows the current quantity to be reflected on the display attributes of objects and allows the quantity changes to be reflected on the display changes in the objects. Additionally, the quantity changes are represented in the display changes and are thus intuitively conveyed to users.
(13) When the data of the categories 41 and 42 are respectively linked to multiple symbols 61 and 62, the data of the corresponding categories 41 and 42 can be extracted by selecting the symbols 61 and 62.
(14) The main screen 46 can display an overview of data. The sub-screen 47 can display additional information related to the upper-level category 41 corresponding to the selected upper-level symbol 61. This configuration allows the overview of data to be displayed on the main screen 46 while selectively displaying additional information on the sub-screen 47 as needed.
(15) Multiple upper-level symbols 61 are each represented as a central star of the planetary system 51 floating in space. This allows the lower-level symbols 62 to be represented as planets revolving along the path 63 centered around one upper-level symbol 61. This allows for a clear visualization of the independent relationships between multiple upper-level categories 41 and the relationships between one upper-level category 41 and multiple lower-level categories 42, by leveraging the natural laws of planetary systems.

### Modifications

The present embodiment may be modified as follows. The present embodiment and the following modifications can be combined as long as they remain technically consistent with each other.

### First Modification

Multiple upper-level symbols 61 may each differ in at least one of shape, size, or color based on the information related to items classified into the corresponding upper-level category 41. For example, the shapes of the upper-level symbols 61 may be modified according to the total sales value or the growth rate of the total sales value. Similarly, multiple lower-level symbols 62 may each differ in at least one of shape, size, or color based on the information related to items classified into the corresponding lower-level category 42.

### Second Modification

The symbols corresponding to categories on different levels, such as the upper-level symbol 61 and the lower-level symbol 62, may each have a different shape. For example, multiple upper-level categories may be represented as a galactic system such that its category name (character object), which is the upper-level symbol 61, is displayed around the galaxy. In this case, the paths 63 of multiple lower-level symbols 62 may be spiral lines extending radially from the center of the galaxy. Additionally, the lower-level symbols 62 may move toward or away from the center, depending on changes in the total sales value or the number of users compared to the corresponding previous period.

### Third Modification

Category classification is not limited to categorizing items. For example, the system and method of the present disclosure may be employed in the categorization of multiple service categories. In this case, the upper-level categories can include, in addition to online shopping, services such as ticket reservations, securities trading, insurance product sales, facility reservations, e-book sales, and consuming contents (e.g., movies or music), and the lower-level categories can be aligned with the categorization of each service. The target of this case may be designated as the users of each service, and the display attributes and dynamic attributes of various objects may be determined based on the number of users or the sales amount. This allows for the execution of analyses for developing marketing strategies that encourage the users of a certain service to use other services.

Alternatively, the system and method of the present disclosure may be employed in the category classification of brands. In this case, analysis may be conducted on the movement patterns of users between upper-level categories (brands) by focusing on the customers (purchasers) of each brand. As another option, the products offered by a specific brand may be classified into categories, and this category classification may be used to analyze the total sales value or the number of users for each category. Such analysis can be used, for example, to consider collaboration partners for projects with brands from other categories or to consider the brands of items to be used in advertising and promotions. Additionally, reward point services that allow mutual reward point conversion can be set as upper-level categories, with the items offered or exchange redemption rewards of each reward point service as lower-level categories.

Web pages or advertisement pages may also be classified. In this case, the analysis of the degree of relevance between pages classified into different categories or the analysis of cross-category customer journeys can be used to assist in creating web pages or advertisement pages and conducting marketing activities.

### Fourth Modification

The correlation degree between categories may also be calculated using a machine learning program. For example, the purchase histories (lists of purchased items) of purchasers (users) may be used as training data and Word2Vec may be used as an algorithm to predict the proximity between categories. For example, a purchaser's shopping list may include “soft drinks,” “outdoor goods,” “running shoes,” and other items. When the purchase lists of purchasers are vectorized in a similar manner, the similarity between the purchasers is calculated. The correlation degree of items or users between categories may be determined based on such similarity.

### Fifth Modification

The representation themes of objects in the display area 50 may be changed according to the category classification or the classification target. For example, when themed around natural ecosystems, objects resembling terrain, flora, or fauna may be set. For example, the scale of quantities may be represented by the height of a mountain or a tree, the length of a river, or the abundance of animals and plants, and the movement speeds of animals may also be controlled. Alternatively, a puzzle-like worldview may be expressed using objects with geometric patterns, or upper-level categories may be represented by similar types of items. For example, one upper-level category may be represented by a clock object, and the variations of information related to a target belonging to the lower-level categories may be expressed through the motion of a pendulum or by the rotation speed of the hour hand, minute hand, or second hand. For the pendulum object, different information may be reflected in display attributes such as the rotation speed, rotation angle, or the length of the pendulum.

### Sixth Modification

The display system or the display method of the present disclosure may be used by the purchaser of items to consider which items to purchase, in addition to being used by the seller of items to manage the items.

### Seventh Modification

The display area 50 is not limited to a two-dimensional display. For example, a three-dimensional display area may be employed using technology such as 3D holograms.

### Eighth Modification

The display attributes of various objects may be determined based on the quantity (e.g., the total sales value, the total sales volume, or the number of purchasers) during the specified period for a target (item) that is classified into each category. In this case, the display attributes (e.g., the shape, size, or color of at least one object) may be determined based on the quantity for the specified period (first period). Further, the dynamic attributes of the object (e.g., the movement speed, movement range, movement distance, manner of change, rate of changes, or range of change) may be determined based on the quantity for the first period and based on the rate of changes (e.g., the rate of increase or decrease) of the quantity between the first period and a second period (e.g., the previous month or the previous year), which is prior to the first period.

### Ninth Modification

The information to be classified may be changed based on the target and category classification. The aggregation period for the data displayed at one time may also be changed. The target information may include, but is not limited to, quantities (e.g., total sales value, total sales volume, or the number of purchasers). For example, the target information may be a score converted from quantitative or qualitative data, or may be a numerical value obtained through computation by a program including a machine learning model.

### Tenth Modification

In the above-described embodiment, multiple upper-level symbols are displayed. Instead, one upper-level symbol may be displayed along with multiple lower-level symbols corresponding to that upper-level symbol. That is, category classification may include one upper-level category and multiple lower-level categories contained in this upper-level category. In this case, multiple objects include one upper-level symbol corresponding to one upper-level category.

Technical concepts that can be understood from each of the above embodiment and modified examples will now be described.

### [Clause 1]

A display system for displaying information that is classified into categories, the category classification including one or more upper-level categories and lower-level categories that are included in each of the upper-level categories, and the one or more upper-level categories and the lower-level categories being used to classify targets, the display system including:
one or more processors; and
one or more memories configured to store display data, where
the display data includes object data for displaying objects in a display area,
the objects include:
   one or more upper-level symbols, each representing a corresponding one of the one or more upper-level categories; and
   lower-level symbols, each representing the lower-level categories,
the one or more processors are configured to, based on information related to the targets that are classified into each of the upper-level categories and the lower-level categories, execute:
   displaying the objects in the display area based on information related to the targets that are classified into each of the upper-level categories and the lower-level categories; and
   changing display of at least one of the objects in the display area.

### [Clause 2]

The display system according to clause 1, where
the at least one of the objects that undergo display changes is a dynamic object,
the one or more processors are configured to, based on information related to the dynamic object from the information related to the targets, execute:
   determining a dynamic attribute of the dynamic object; and
   changing display of the dynamic object based on the dynamic attribute, and
the dynamic attribute includes at least one of movement speed, movement range, display range, or rate of display change.

### [Clause 3]

The display system according to clause 1 or 2, where
the one or more processors are configured to execute:
   determining a display attribute of the at least one of the objects based on information related to a corresponding one of the objects from the information related to the targets; and
   displaying the objects in the display area based on the display attribute, and the display attribute includes at least one of shape, size, color, or arrangement.

### [Clause 4]

The display system according to clause 3, where
the determining the display attribute includes determining arrangement of the lower-level symbols relative to one of the upper-level symbols based on information related to targets classified into corresponding ones of the lower-level categories.

### [Clause 5]

The display system according to any one of clauses 1 to 4, where
the changing the display includes moving the lower-level symbols along a path with respect to a corresponding one of the upper-level symbols.

### [Clause 6]

The display system according to clause 5, where
the path has a shape of an arc, an ellipse, or a circle centered around the one of the upper-level symbols, and
each of path planes of the paths centered around the one of the upper-level symbols is inclined with respect to the same reference plane at an inclination angle corresponding to information related to the target classified into a corresponding one of the lower-level categories.

### [Clause 7]

The display system according to any one of clauses 1 to 6, where
the one or more upper-level categories include multiple upper-level categories,
the one or more upper-level symbols include multiple upper-level symbols,
the objects include a line connecting at least two of the upper-level symbols to each other, and
the line represents a correlation or a correlation level between two of the upper-level categories corresponding to the two of the upper-level symbols connected to each other by the line.

### [Clause 8]

The display system according to clause 7, where
the targets include multiple items regarding products or services transacted on an EC site,
the display system comprises a user database configured to store information related to users of the EC site,
the user database includes a purchase history of each of the users on the EC site,
the line is a movement line indicating a movement pattern of the user between the upper-level categories, and
the movement pattern includes a pattern in which a user who has purchased an item classified into one of the two of the upper-level categories during a period purchases an item classified into the other one of the two of the upper-level categories during another period.

### [Clause 9]

The display system according to clause 3, where
the one or more upper-level categories include multiple upper-level categories,
the one or more upper-level symbols include multiple upper-level symbols, and
the determining the display attributes of the objects includes determining distances between the upper-level symbols based on a correlation level between corresponding ones of the upper-level categories.

### [Clause 10]

The display system according to clause 7 or 9, where
the targets include multiple items regarding products or services transacted on an EC site, and
the correlation level between two of the upper-level categories is calculated based on the number of purchasers who have purchased two items that are respectively classified into two corresponding ones of the upper-level categories.

### [Clause 11]

The display system according to any one of clauses 1 to 10, where
the targets include multiple items regarding products or services transacted on an EC site,
the information related to the targets includes a quantity for a specified period, the quantity being related to an item classified into each of the categories, and
the quantity includes at least one of a total sales value, a total sales volume, or the number of purchasers.

### [Clause 12]

The display system according to any one of clauses 1 to 11, where
the at least one of the objects that undergo display changes is a dynamic object,
the one or more processors are configured to execute:
   determining a display attribute of at least one of the objects based on information related to a corresponding one of the objects from the information related to the targets;
   displaying the objects in the display area based on the display attribute;
   determining a dynamic attribute of at least one of the dynamic objects based on information related to a corresponding one of the dynamic objects from the information related to the targets; and
   controlling display of the at least one of the dynamic objects based on the dynamic attribute,
the display attribute is determined based on the quantity for the specified period, and
the dynamic attribute is determined based on a rate of change between the quantity for the specified period and a quantity for a period prior to the specified period.

### [Clause 13]

The display system according to any one of clauses 1 to 12, where
the display system includes a database configured to store data related to the targets,
at least one type of the object data is linked to data related to a corresponding one of the objects in the data stored in the database, and
the displaying includes displaying, when one of the objects is selected, data linked to the selected object.

### [Clause 14]

The display system according to any one of clauses 1 to 13, where
the display area is a two-dimensional display screen, the display screen including a main screen for displaying the objects and a sub-screen aligned with the main screen,
the one or more processors are configured to execute displaying, when one of the one or more upper-level symbols is selected on the main screen, additional information related to the upper-level category corresponding to the selected upper-level symbol on the sub-screen, and
the additional information includes information related to each of the lower-level categories that are included in the upper-level category.

### [Clause 15]

The display system according to any one of clauses 1 to 14, where
the display data includes background data,
a background represented by the background data expresses space in two or more dimensions,
each of the upper-level symbols is represented as a central star of a planetary system floating in space, and
the lower-level symbols corresponding to one of the upper-level symbols are represented as planets revolving along a path centered around a corresponding one of the central stars.

### [Clause 16]

A display method for displaying information that is classified into categories, the category classification including one or more upper-level categories and lower-level categories that are included in each of the upper-level categories, and the one or more upper-level categories and the lower-level categories being used to classify targets, the method including:
causing a computer to, based on information related to the targets that are classified into each of the upper-level categories and the lower-level categories, execute:
displaying the objects in the display area, where the objects include:
   one or more upper-level symbols, each representing a corresponding one of the one or more upper-level categories; and
   lower-level symbols, each representing the lower-level categories; and changing display of at least one of the objects in the display area.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A display system for displaying information that is classified into categories, the category classification including one or more upper-level categories and lower-level categories that are included in each of the upper-level categories, and the one or more upper-level categories and the lower-level categories being used to classify targets, the display system comprising:
one or more processors; and
one or more memories that store computer program code and display data, wherein
the display data includes object data for displaying objects in a display area,
the objects include:
one or more upper-level symbols, each representing a corresponding one of the one or more upper-level categories; and
lower-level symbols, each representing the lower-level categories,
the one or more processors are configured to read the program code and operate as instructed by the program code, and
the program code includes:
object display code configured to display the objects in the display area based on information related to the targets that are classified into each of the upper-level categories and the lower-level categories; and
object change code configured to change display of at least one of the objects in the display area.

2. The display system according to claim 1, wherein
the at least one of the objects that undergo display changes is a dynamic object,
the program code includes:
dynamic attribute determination code configured to determine a dynamic attribute of the dynamic object based on information related to the dynamic object from the information related to the targets, the dynamic attribute including at least one of movement speed, movement range, display range, or rate of display change; and
the object change code configured to change display of the dynamic object based on the dynamic attribute.

3. The display system according to claim 1, wherein
the program code includes:
display attribute determination code configured to determine a display attribute of the at least one of the objects based on information related to a corresponding one of the objects from the information related to the targets, the display attribute including at least one of shape, size, color, or arrangement; and
the object display code configured to display the objects in the display area based on the display attribute.

4. The display system according to claim 3, wherein
the display attribute determination code is configured to determine arrangement of the lower-level symbols relative to one of the upper-level symbols based on information related to targets classified into corresponding ones of the lower-level categories.

5. The display system according to claim 1, wherein
the object change code is configured to move the lower-level symbols along a path with respect to a corresponding one of the upper-level symbols.

6. The display system according to claim 5, wherein
the path has a shape of an arc, an ellipse, or a circle centered around the one of the upper-level symbols, and
each of path planes of the paths centered around the one of the upper-level symbols is inclined with respect to the same reference plane at an inclination angle corresponding to information related to the target classified into a corresponding one of the lower-level categories.

7. The display system according to claim 1, wherein
the one or more upper-level categories include multiple upper-level categories,
the one or more upper-level symbols include multiple upper-level symbols,
the objects include a line connecting at least two of the upper-level symbols to each other, and
the line represents a correlation or a correlation level between two of the upper-level categories corresponding to the two of the upper-level symbols connected to each other by the line.

8. The display system according to claim 7, wherein
the targets include multiple items regarding products or services transacted on an EC site,
the display system comprises a user database configured to store information related to users of the EC site,
the user database includes a purchase history of each of the users on the EC site,
the line is a movement line indicating a movement pattern of the user between the upper-level categories, and
the movement pattern includes a pattern in which a user who has purchased an item classified into one of the two of the upper-level categories during a period purchases an item classified into the other one of the two of the upper-level categories during another period.

9. The display system according to claim 3, wherein
the one or more upper-level categories include multiple upper-level categories,
the one or more upper-level symbols include multiple upper-level symbols, and
the display attribute determination code is configured to determine distances between the upper-level symbols based on a correlation level between corresponding ones of the upper-level categories.

10. The display system according to claim 9, wherein
the targets include multiple items regarding products or services transacted on an EC site, and
the correlation level between two of the upper-level categories is calculated based on the number of purchasers who have purchased two items that are respectively classified into two corresponding ones of the upper-level categories.

11. The display system according to claim 1, wherein
the targets include multiple items regarding products or services transacted on an EC site,
the information related to the targets includes a quantity for a specified period, the quantity being related to an item classified into each of the categories, and
the quantity includes at least one of a total sales value, a total sales volume, or the number of purchasers.

12. The display system according to claim 11, wherein
the at least one of the objects that undergo display changes is a dynamic object,
the program code includes:
display attribute determination code configured to determine a display attribute of at least one of the objects based on information related to a corresponding one of the objects from the information related to the targets;
the object display code configured to display the objects in the display area based on the display attribute;
dynamic attribute determination code configured to determine a dynamic attribute of at least one of the dynamic objects based on information related to a corresponding one of the dynamic objects from the information related to the targets; and
the object change code configured to control display of the at least one of the dynamic objects based on the dynamic attribute,
the display attribute is determined based on the quantity for the specified period, and
the dynamic attribute is determined based on a rate of change between the quantity for the specified period and a quantity for a period prior to the specified period.

13. The display system according to claim 1, wherein
the display system includes a database configured to store data related to the targets,
at least one type of the object data is linked to data related to a corresponding one of the objects in the data stored in the database, and
the object display code is configured to display, when one of the objects is selected, data linked to the selected object.

14. The display system according to claim 1, wherein
the display area is a two-dimensional display screen, the display screen including a main screen for displaying the objects and a sub-screen aligned with the main screen,
the program code includes additional information display code configured to display, when one of the one or more upper-level symbols is selected on the main screen, additional information related to the upper-level category corresponding to the selected upper-level symbol on the sub-screen, and
the additional information includes information related to each of the lower-level categories that are included in the upper-level category.

15. The display system according to claim 1, wherein
the display data includes background data,
a background represented by the background data expresses space in two or more dimensions,
each of the upper-level symbols is represented as a central star of a planetary system floating in space, and
the lower-level symbols corresponding to one of the upper-level symbols are represented as planets revolving along a path centered around a corresponding one of the central stars.

16. A display method for displaying information that is classified into categories, the category classification including one or more upper-level categories and lower-level categories that are included in each of the upper-level categories, and the one or more upper-level categories and the lower-level categories being used to classify targets, the method comprising:
causing a computer to, based on information related to the targets that are classified into each of the upper-level categories and the lower-level categories, execute:
displaying the objects in the display area, wherein the objects include:
one or more upper-level symbols, each representing a corresponding one of the one or more upper-level categories; and
lower-level symbols, each representing the lower-level categories; and
changing display of at least one of the objects in the display area.
